(19) United States
(12) Patent Application Publication
(10) Pub. No.: US 2025/0209315 A1
(43) Pub. Date: Jun. 26, 2025

(54) METHOD OF OPERATING AN ARTIFICIAL NEUERAL NETWORK MODEL AND A STORAGE DEVICE PERFORMING THE SAME

(71) Applicant: SAMSUNG ELECTRONICS CO., LTD., SUWON-SI (KR)

(72) Inventor: SOOYOUNG JI, SUWON-SI (KR)

(21) Appl. No.: 18/768,743

(22) Filed: Jul. 10, 2024

(30) Foreign Application Priority Data
Dec. 26, 2023 (KR) 10-2023-0190899

(51) Int. Cl. G06N 3/0499; G06N 3/082; G06N 5/046

(52) U.S. Cl. CPC G06N 3/0499; G06N 3/082; G06N 5/046

(57) ABSTRACT

A method of operating an artificial neural network model including a plurality of nodes includes: dividing the artificial neural network model into a divided artificial neural network including plurality node groups using a first grouping manner, allocating the plurality of node groups to a plurality of first hardware accelerators and a plurality of second hardware accelerators using a first corresponding manner to generate an allocation, executing the divided artificial neural network model on a plurality of input values to generate a plurality of inference results values, for each of the plurality of inference result values, recording activation area information of the plurality of node groups and a call count, and performing at least one of a first operation to change the allocation and a second operation to change the divided artificial neural network based on the activation area information and the call count.

### CROSS-REFERENCE TO RELATED APPLICATION

This patent application claims priority under 35 USC § 119 to Korean Patent Application No. 10-2023-0190899 filed on Dec. 26, 2023 in the Korean Intellectual Property Office (KIPO), the disclosure of which is incorporated by reference in its entirety herein.

### 1. TECHNICAL FIELD

Example embodiments are directed to a semiconductor integrated circuit, and more particularly to a method of operating an artificial neural network model.

### 2. DISCUSSION OF RELATED ART

Artificial intelligence (AI) is the branch of computer science that focuses on creating systems capable of performing tasks that normally require human intelligence. The human brain is made up of numerous nerve cells called neurons. An artificial neural network (ANN) model is a computational model inspired by the structure and functional aspects of biological neural networks. The ANN model includes neurons (e.g., also referred to as nodes) organized into several layers, which include an input layer, hidden layers, and an output layer.

Recently, due to the development of artificial intelligence-related technology, the provision of systems and services using artificial intelligence is increasing. For example, as the performance of systems or services using artificial intelligence increases, artificial neural network models are becoming larger. As artificial neural network models become larger, significant resources are required to operate and manage artificial neural network models. Therefore, systems and methods are needed to efficiently execute artificial neural network models when resources are limited.

### SUMMARY

At least one example embodiment of the present disclosure provides a method of operating an artificial neural network model for effectively performing inference operations using an artificial neural network model in which multiple node groups are set.

At least one example embodiment of the present disclosure provides a storage device performing the method of operating an artificial neural network model.

According to an example embodiment, a method of operating an artificial neural network model including a plurality of nodes includes is provided. The method includes: dividing the artificial neural network model into a divided artificial neural network including a plurality of node groups using a first grouping manner, each of the plurality of node groups including at least one of the plurality of nodes; allocating a first subset of the plurality of node groups to a plurality of first hardware accelerators and a second other subset of the plurality of node groups to a plurality of second hardware accelerators using a first corresponding manner to generate an allocation, where operating speeds of the plurality of second hardware accelerators are faster than operating speeds of the plurality of first hardware accelerators; executing the divided artificial neural network model on a plurality of input values using the plurality of first and second hardware accelerators to generate a plurality of inference results values; for each of the plurality of inference result values, recording activation area information of the plurality of node groups and a call count; and performing at least one of a first operation to change the allocation and a second operation to change the divided artificial neural network model, based on the activation area information and the call count.

According to an example embodiment, a storage device includes, a plurality of non-volatile memories configured to store an artificial neural network model including a plurality of nodes, a plurality of hardware accelerators configured to calculate a plurality of inference result values based on a plurality of input values and the artificial neural network model, and a storage controller configured to control the plurality of non-volatile memories and the plurality of hardware accelerators. The storage controller includes, a model splitting module configured to divide the artificial neural network model into a plurality of node groups, each of the plurality of node groups including at least one of the plurality of nodes, a node group allocating module configured to allocate each of the plurality of node groups to a corresponding one of the plurality of hardware accelerators to generate an allocation, and a recording module configured to, for each of the plurality of inference result values, record activation area information of the plurality of node groups and a call count. The node group allocating module is configured to perform a first operation to change the allocation based on the activation area information and the call count. The model splitting module is configured to perform a second operation to change the divided artificial neural network based on the activation area information and the call count.

According to an example embodiment, a method of operating an artificial neural network model including a plurality of nodes is provided. The method includes: dividing the artificial neural network model into a divided artificial neural network including a plurality of node groups using a first grouping manner, each of the plurality of node groups including at least one of the plurality of nodes; allocating a first subset of the plurality of node groups to a plurality of first hardware accelerators and a second other subset of the plurality of node groups to plurality of second hardware accelerators using a first corresponding manner, where operating speeds of the plurality of second hardware accelerators are faster than operating speeds of the plurality of first hardware accelerators; executing the divided artificial neural network model on a plurality of input values using the plurality of first and second hardware accelerators to generate a plurality of inference result values; for each of the plurality of inference result values, recording activation area information of the plurality of node groups and a call count; selecting a first reference inference result value among the plurality of inference result values; reallocating the plurality of node groups to the plurality of first and second hardware accelerators using a second corresponding manner different from the first corresponding manner based on the activation area information of the plurality of node groups for the first reference inference result value; and dividing the artificial neural network model into a new divided artificial neural network using a second grouping manner different from the first grouping manner, based on the first activation area information.

In a method of operating the artificial neural network model and the storage device performing the method according to example embodiments, a node group having a high activation level may be preferentially reallocated to the plurality of second hardware accelerators that have a faster operating speed than that of the plurality of first hardware accelerators. Thus, the execution time of the artificial neural network model may be shortened and the power consumption of devices that perform inference operations may be reduced. Additionally, a plurality of node groups may be adjusted such that the number of nodes included in frequently called node groups is reduced based on activation area information and call count. Thus, memory space limitations and computation limitations may be overcome without a significant difference in the execution time of the artificial neural network model before and after the adjustment.

### BRIEF DESCRIPTION OF THE DRAWINGS

FIG. 1 is a flowchart illustrating a method of operating an artificial neural network model according to an example embodiment.

FIGS. 2 and 3 are block diagrams illustrating a method of operating an artificial neural network model and/or a system performing a method of operating an artificial neural network model according to an example embodiment.

FIG. 4 is a diagram illustrating activation area information and setting a plurality of node groups in a method of operating an artificial neural network model according to an example embodiment.

FIG. 5 is a diagram for describing a call count and inference operation in a method of operating an artificial neural network model according to an example embodiment.

FIG. 6 is a flowchart illustrating a first operation in a method of operating an artificial neural network model according to an example embodiment.

FIGS. 7 and 8 are diagrams for describing a first operation in a method of operating an artificial neural network model according to an example embodiment.

FIG. 9 is a flowchart illustrating a second operation in a method of operating an artificial neural network model according to an example embodiment.

FIGS. 10 and 11 are diagrams for describing a second operation in a method of operating an artificial neural network model according to an example embodiment.

FIGS. 12 and 13 are diagrams illustrating examples of a manner of grouping nodes in a method of operating an artificial neural network model according to an example embodiment.

FIG. 14 is a block diagram illustrating a storage device and a storage system including the storage device according to an example embodiment.

FIG. 15 is a block diagram illustrating a storage controller included in a storage device according to an example embodiment.

FIG. 16 is a diagram illustrating an example of a storage device according to an example embodiment.

### DETAILED DESCRIPTION

Various example embodiments will be described more fully with reference to the accompanying drawings. The present disclosure may, however, be embodied in many different forms and should not be construed as limited to the embodiments set forth herein. Like reference numerals refer to like elements throughout this application.

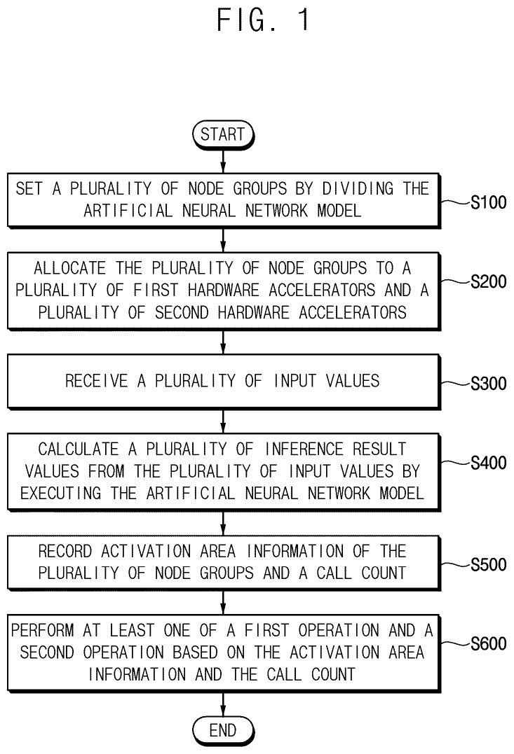

FIG. 1 is a flowchart illustrating a method of operating an artificial neural network model according to an example embodiment.

The method of FIG. 1 may be performed on a device that performs an inference operation by dividing an artificial neural network model into parts and allocating the parts to a plurality of hardware accelerators. Examples of the hardware accelerators include graphic processing units (GPUs), field-programmable gate arrays (FPGAs), application-specific integrated circuits (ASICs), and digital signal processors (DSPs). For example, the device that performs the inference operation may be a storage device, but example embodiments are not limited thereto, and the device that performs the inference operation may be at least one of various electronic devices. For example, the storage device may include the hardware accelerators.

An artificial neural network model includes multiple layers, where each layer includes multiple nodes. A node group may include some or all nodes of one or more layers of the artificial neural network model. For example, in an artificial neural network model including an input layer, a hidden layer, and an output layer, the model could be divided into a first node group including a first half of the nodes of the input layer, a first half of the nodes of the hidden layer, and a first half of the nodes of the output layer; and a second node group including a second half of the nodes of the input layer, a second half of the nodes of the hidden layer, and a second half of the nodes of the output layer.

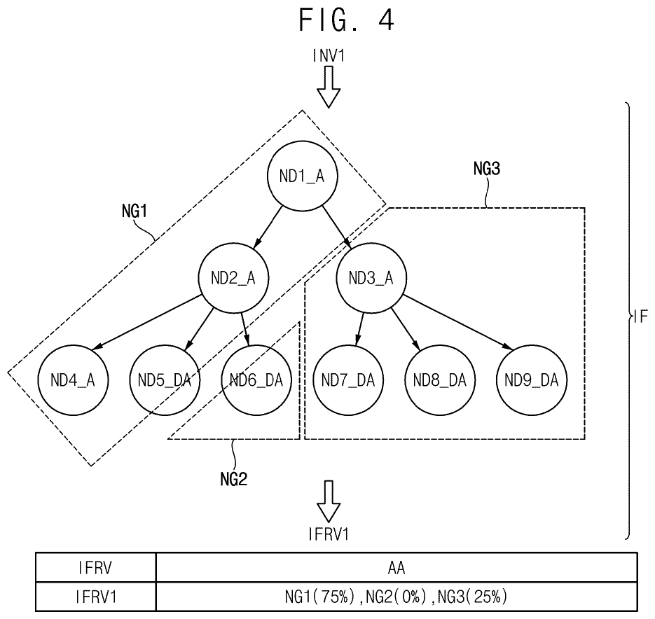

The method of FIG. 1 includes dividing an artificial neural network model into a plurality of node groups (operation S100). For example, the artificial neural network model may represent a prediction technique based on a mathematical brain model. For example, the artificial neural network model may include a plurality of nodes, a plurality of layers, a plurality of weights, etc. For example, the artificial neural network model may be divided using at least one of various grouping manners. For example, a grouping manner at the beginning of an operation may be referred to as a first grouping manner. A grouping manner will be described with reference to FIGS. 4, 12, and 13.

For example, the artificial neural network model may include a plurality of nodes and may be divided into a plurality of node groups. For example, each of the plurality of node groups may include at least one of the plurality of nodes. For example, if the device that performs the inference operation is a storage device and the storage device includes a total of N (N is a positive integer) hardware accelerators to execute the artificial neural network model, the artificial neural network model may be divided into N node groups.

The method of FIG. 1 further includes allocating the plurality of node groups to a plurality of first and second hardware accelerators (operation S200). For example, when N is 5, the first to second node groups could be allocated to respectively to two hardware accelerators of a first type (i.e., the first hardware accelerators) and the third to fifth node groups could be respectively allocated to three hardware accelerators of a second type different from the first type (i.e., the second hardware accelerators). For example, the plurality of first and second hardware accelerators may be included in a storage device. For example, the plurality of first and second hardware accelerators may represent devices that perform some functions in computing faster than a central processing unit (CPU). For example, the plurality of first and second hardware accelerators may represent devices that perform inference operations faster than a central processing unit included in the storage device.

For example, operating speeds of the plurality of second hardware accelerators may be faster than operating speeds of the plurality of first hardware accelerators. For example, the plurality of node groups may be allocated to the plurality of first and second hardware accelerators using various corresponding manners. For example, a corresponding manner at the beginning of operation may be referred to as a first corresponding manner. For example, a single node group among the plurality of node groups may be assigned to a single hardware accelerator among the first and second hardware accelerators.

The method of FIG. 1 includes receiving a plurality of input values (operation S300). For example, the plurality of input values may represent data input from one or more users for the inference operation rather than preset test data.

The method of FIG. 1 includes calculating a plurality of inference results from the plurality of input values by executing the artificial neural network model (operation S400). For example, the artificial neural network model in which the plurality of node groups are set may be executed using the plurality of first and second hardware accelerators. For example, each of the plurality of first and second hardware accelerators may perform a sub-inference operation on the input values using a single allocated node group to generate a plurality of sub-inference result values, and the inference result value may be calculated from the plurality of sub-inference result values.

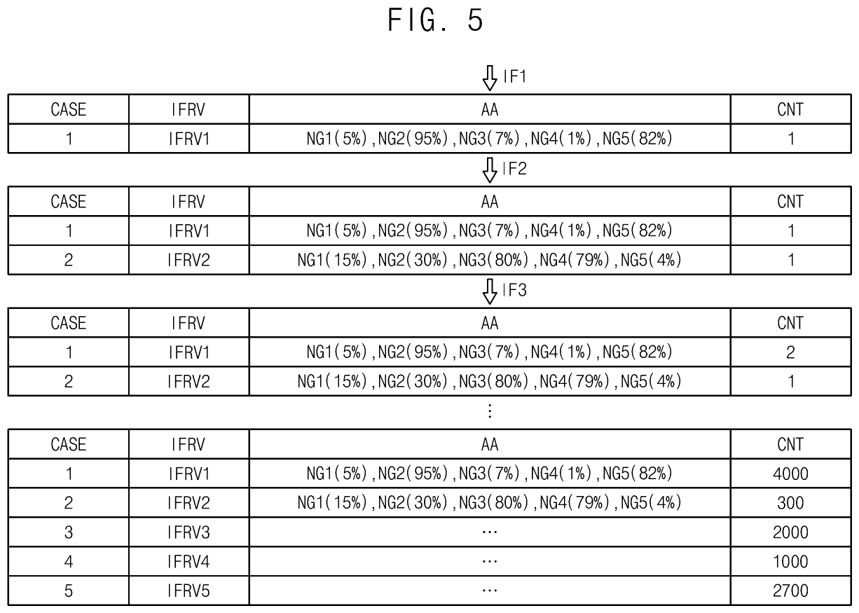

The method of FIG. 1 includes recording activation area information of the plurality of node groups and a call count for each of the plurality of inference result values (i.e., the sub-inference result values) (operation S500). For example, the activation area information may include information indicating which of the plurality of nodes is activated when the artificial neural network model is executed. For example, a node in a neural network is activated when that node has applied an activation function to its input. For example, the activation area information may be recorded while performing operation S400. The activation area information will be described with reference to FIG. 4. For example, the call count may represent the number of times each of the plurality of inference result values is calculated. For example, the call count may be recorded after operation S400 ends. The call count will be described with reference to FIG. 5.

For example, operations S300, S400, and S500 may be performed repeatedly. For example, operations S300, S400, and S500 may represent a single inference operation, and when performing the single inference operation M (M is a positive integer) times, a plurality of activation area information and a plurality of call counts for the plurality of inference result values may be generated. For example, operation S600 may be performed based on the plurality of activation area information and the plurality of call counts for the plurality of inference result values.

The method of FIG. 1 includes performing at least one of a first operation and a second operation based on the activation area information and the call counts (operation S600). For example, an allocation between the plurality of node groups and the plurality of first and second hardware accelerators may be changed by the first operation. For example, a division of the artificial neural network model may be changed by the second operation.

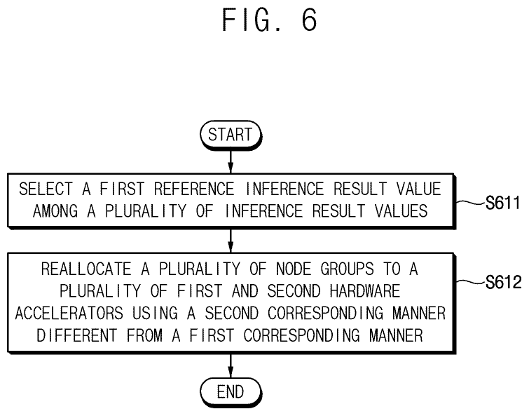

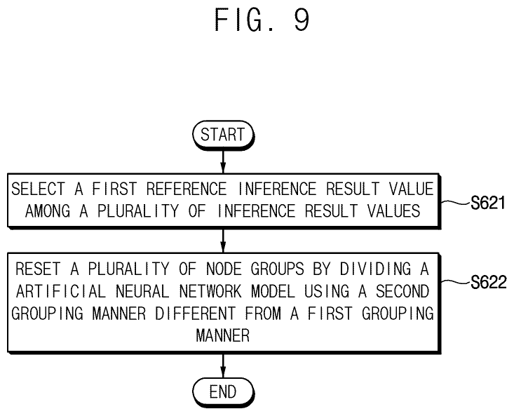

For example, the first operation may represent an operation of allocating the plurality of node groups using a corresponding manner different from the corresponding manner (e.g., the first corresponding manner) in operation S200. The first operation will be described with reference to FIGS. 6, 7, and 8. For example, the second operation may represent an operation of setting the plurality of node groups using a grouping manner different from the grouping manner (e.g., the first grouping manner) in operation S100. The second operation will be described with reference to FIGS. 9, 10, and 11.

In an embodiment, a node group having a high activation level is preferentially reallocated to the plurality of second hardware accelerators that have a faster operating speed than that of the plurality of first hardware accelerators, and accordingly, the execution time of the artificial neural network model may be shortened and the power consumption of devices that perform inference operations may be reduced. In an embodiment, if a first node group has a higher activation level than a second node group, more nodes of the first node group have been activated than nodes of the second node group in calculating the result of the neural network model. For example, a plurality of node groups may be reset such that the number of nodes included in frequently called node groups is reduced, and thus memory space limitations and computation limitations may be overcome without a significant difference in the execution time of the artificial neural network model before and after the reset. For example, the node groups may be recalculated when it is determined that a first node group of the node groups is executed more frequently than a certain threshold, so that the first node group includes less nodes than before or a smaller portion of the neural network.

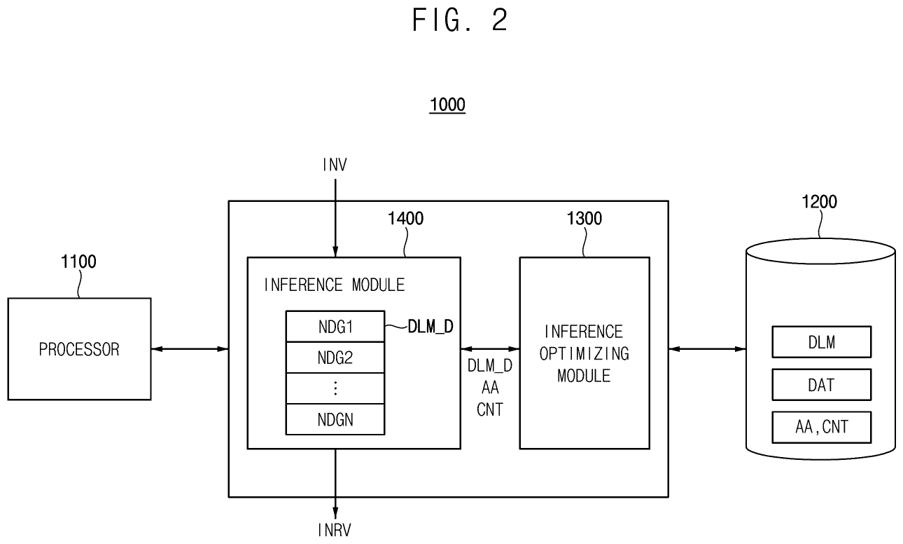

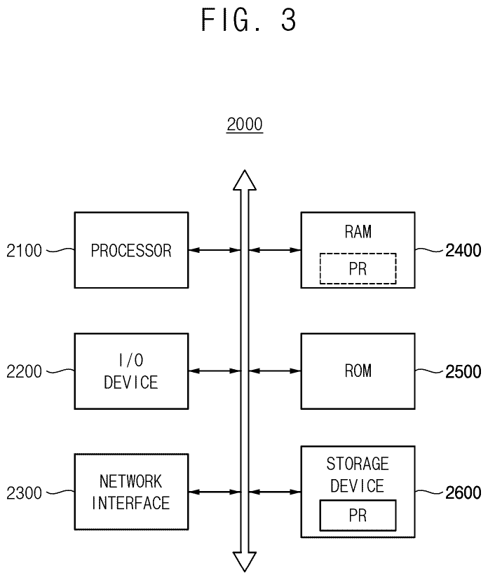

FIGS. 2 and 3 are block diagrams illustrating a method of operating an artificial neural network model and/or a system operating a method of operating an artificial neural network model according to an example embodiment.

Referring to FIG. 2, a system 1000 includes a processor 1100, a storage device 1200, an inference optimizing module 1300, and an inference module 1400.

Herein, the term “module” may indicate, but is not limited to, software and/or hardware component, such as a field programmable gate array (FPGA) or an application specific integrated circuit (ASIC), which performs certain tasks. A module may be configured to reside in a tangible addressable storage medium and be configured to execute on one or more processors. For example, a “module” may include components such as software components, object-oriented software components, class components and task components, and processes, functions, routines, segments of program code, drivers, firmware, microcode, circuitry, data, databases, data structures, tables, arrays, and variables. A “module” may be divided into a plurality of “modules” that perform detailed functions.

In some example embodiments, the system 1000 may be a computing system and may be provided as a dedicated system for a method of operating an artificial neural network model according to example embodiments.

The processor 1100 may control an operation of the system 1000, and may be utilized when the inference optimizing module 1300 and the inference module 1400 perform computations or calculations. For example, the processor 1100 may include a micro-processor, an application processor (AP), a central processing unit (CPU), a digital signal processor (DSP), a graphic processing unit (GPU) or a neural processing unit (NPU). Although FIG. 2 illustrates that the system 1000 includes one processor 1100, example embodiments are not limited thereto. For example, the system 1000 may include a plurality of processors. In addition, the processor 1100 may include cache memories to increase computation capacity.

The storage device 1200 may store data used for the operation of the system 1000 and/or an operation of the inference optimizing module 1300 and the inference module 1400. For example, the storage device 1200 may store a deep learning model (or data related to the deep learning model) DLM, a plurality of data DAT, activation area information AA of a plurality of node groups NDG1, NDG2, . . . , and NDGN, and a call count CNT. For example, the plurality of data DAT may include sample data, simulation data, real data, and various other data. The real data may also be referred to herein as actual data or measured data from the manufactured semiconductor device and/or a manufacturing process. The deep learning model DLM may be provided from the storage device 1200 to the inference optimizing module 1300. The inference optimizing module 1300 may divide the deep learning model DLM to generate a divided deep learning model DLM_D including the plurality of node groups NDG1, NDG2, . . . , and NDGN, and may provide the divided deep learning model DLM_D to the inference module 1400. The deep learning model DLM may include a generative model that learns training data and generates similar data that follows the distribution of the training data. Hereinafter, the deep learning model DLM may be used with substantially the same meaning as an inference model or an artificial neural network model.

In some example embodiments, the storage device (or storage medium) 1200 may include any non-transitory computer-readable storage medium used to provide commands and/or data to a computer. For example, the non-transitory computer-readable storage medium may include a volatile memory such as a static random access memory (SRAM), a dynamic random access memory (DRAM), or the like, and a nonvolatile memory such as a flash memory, a magnetic random access memory (MRAM), a phase-change random access memory (PRAM), a resistive random access memory (RRAM), or the like. The non-transitory computer-readable storage medium may be inserted into the computer, may be integrated in the computer, or may be coupled to the computer through a communication medium such as a network and/or a wireless link.

The inference optimizing module 1300 may generate the divided deep learning model DLM_D in which the plurality of node groups NDG1, NDG2, . . . , and NDGN are set based on the deep learning model DLM.

For example, the inference optimizing module 1300 may set the plurality of node groups NDG1, NDG2, . . . , and NDGN based on the deep learning model DLM. For example, the inference optimizing module 1300 may allocate the plurality of node groups NDG1, NDG2, . . . , and NDGN to a plurality of hardware accelerators. For example, while the inference module 1400 performs an inference operation using the deep learning model DLM in which the plurality of node groups NDG1, NDG2, . . . , and NDGN are set, the activation area information AA of the plurality of node groups NDG1, NDG2, . . . , and NDGN and the call count CNT may be recorded.

In addition, based on the activation area information AA of the plurality of node groups NDG1, NDG2, . . . , and NDGN and the call count CNT, the inference optimizing module 1300 may perform a first operation that changes a manner of allocating the plurality of node groups NDG1, NDG2, . . . , and NDGN to the plurality of hardware accelerators and a second operation that changes a manner of dividing the artificial neural network model. In this case, the deep learning model DLM may be the artificial neural network model in FIG. 1. For example, the inference optimizing module 1300 may perform operations S100, S200, S500, and S600 in FIG. 1.

The inference module 1400 may generate an inference result value IFRV based on an input value INV. The inference module 1400 may perform an inference operation using the deep learning model DLM in which the plurality of node groups NG1, NG2, . . . , and NDGN are set.

For example, the inference module 1400 may receive the input value INV and may perform the inference operation on the input value INV using (e.g., executing) the deep learning model DLM. In this case, the deep learning model DLM may be the artificial neural network model in FIG. 1. For example, the inference module 1400 may perform operations S300 and S400 in FIG. 1.

In some example embodiments, the inference optimizing module 1300 and the inference module 1400 may be implemented in the form of instructions or program code executed by the processor 1100. For example, the inference optimizing module 1300 and the inference module 1400 may be stored in a computer-readable recording medium. At this time, the processor 1100 may load instructions or program code of the inference optimizing module 1300 and the inference module 1400 to a working memory (e.g., DRAM, etc.).

In other example embodiments, the processor 1100 may be manufactured to perform functions of the inference optimizing module 1300 and the inference module 1400. For example, the processor 1100 may implement the inference optimizing module 1300 and the inference module 1400 by receiving information corresponding to the inference optimizing module 1300 and the inference module 1400.

Referring to FIG. 3, a system 2000 includes a processor 2100, an input/output (I/O) device 2200, a network interface 2300, a random access memory (RAM) 2400, a read only memory (ROM) 2500 and/or a storage device 2600. FIG. 3 illustrates an example where all of components of the inference optimizing module 1300 and the inference module 1400 in FIG. 2 are implemented in software.

The system 2000 may be a computing system. For example, the computing system may be a fixed computing system such as a desktop computer, a workstation or a server, or may be a portable computing system such as a laptop computer.

The processor 2100 may be substantially the same as the processor 1100 in FIG. 2. For example, the processor 2100 may include a core or a processor core for executing an arbitrary instruction set (for example, intel architecture-32 (IA-32), 64 bit extension IA-32, x86-64, PowerPC, Sparc, MIPS, ARM, IA-64, etc.). For example, the processor 2100 may access a memory (e.g., the RAM 2400 or the ROM 2500) through a bus, and may execute instructions stored in the RAM 2400 or the ROM 2500. As illustrated in FIG. 3, the RAM 2400 may store a program PR corresponding to the inference optimizing module 1300 and the inference module 1400 in FIG. 2 or at least some elements of the program PR, and the program PR may enable the processor 2100 to perform operations for dividing into a plurality of node groups (e.g., a portion of operations S100 and S600 in FIG. 1) and/or operations for allocating the plurality of node groups to a plurality of hardware accelerators (e.g., a portion of operations S200 and S600 in FIG. 1) and/or operations for recording activation area information of the plurality of node groups and call counts (e.g., operation S500 in FIG. 1) and/or operations of performing an inference on input values (e.g., operations S300 and S400 in FIG. 1).

In other words, the program PR may include a plurality of instructions and/or procedures executable by the processor 2100, and the plurality of instructions and/or procedures included in the program PR may enable the processor 2100 to perform a method of operating an artificial neural network model according to example embodiments. Each of the procedures may denote a series of instructions for performing a certain task. A procedure may be referred to as a function, a routine, a subroutine, or a subprogram. Each of the procedures may process data provided from the outside and/or data generated by another procedure.

In some example embodiments, the RAM 2400 may include any volatile memory such as an SRAM or a DRAM.

The storage device 2600 may store the program PR. The program PR or at least some elements of the program PR may be loaded from the storage device 2600 to the RAM 2400 before being executed by the processor 2100. The storage device 2600 may store a file written in a program language, and the program PR generated by a compiler or at least some elements of the program PR may be loaded to the RAM 2400.

The storage device 2600 may store data, which is to be processed by the processor 2100, or data obtained through processing by the processor 2100. The processor 2100 may process the data stored in the storage device 2600 to generate new data, based on the program PR and may store the generated data in the storage device 2600.

The I/O device 2200 may include an input device, such as a keyboard or a pointing device, and may include an output device such as a display device or a printer. For example, a user may trigger, through the I/O devices 2200, execution of the program PR by the processor 2100, and may provide or check various inputs, outputs and/or data, etc.

The network interface 2300 may provide access to a network outside the system 2000. For example, the network may include a plurality of computing systems and communication links, and the communication links may include wired links, optical links, wireless links, or arbitrary other type links. Various inputs may be provided to the system 2000 through the network interface 2300, and various outputs may be provided to another computing system through the network interface 2300.

In some example embodiments, the computer program code and/or the inference module 1400 may be stored in a transitory or non-transitory computer readable medium. In some example embodiments, result values from an inference operation performed by the processor 2100 or values obtained from arithmetic processing performed by the processor 2100 may be stored in a transitory or non-transitory computer readable medium. In some example embodiments, intermediate values during the inference operation and/or various data generated by the inference operation may be stored in a transitory or non-transitory computer readable medium. However, example embodiments are not limited thereto.

FIG. 4 is a diagram illustrating activation area information and setting a plurality of node groups in a method of operating an artificial neural network model according to an example embodiment.

Referring to FIG. 4, a plurality of node groups NG1, NG2, and NG3 may be set based on an artificial neural network model including a plurality of nodes ND1_A, ND2_A, ND3_A, ND4_A, ND5_DA, ND6_DA, ND7_DA, ND8_DA, and ND9_DA, and activation area information AA may be obtained while an inference operation IF is performed. The inference operation IF may be an operation executing the artificial neural network model on the first input value INV1 to calculate a first inference result value IFRV1.

For example, the first node group NG1 may be set to include first, second, fourth, and fifth nodes ND1_A, ND2_A, ND4_A, and ND5_DA. For example, the second node group NG2 may be set to include the sixth node ND6_DA. For example, the third node group NG3 may be set to include the third, seventh, eighth, and ninth nodes ND3_A, ND7_DA, ND8_DA, and ND9_DA. For example, before executing the artificial neural network model, the first to third node groups NG1, NG2, and NG3 may be set as shown in FIG. 4.

For example, the first to fourth nodes ND1_A, ND2_A, ND3_A, and ND4_A may represent activated nodes that are activated while the inference operation IF is performed. For example, the activated nodes may represent nodes that have been accessed or data has been routed to at least once while the inference operation IF is performed. For example, the fifth to ninth nodes ND5_DA, ND6_DA, ND7_DA, ND8_DA, and ND9_DA may represent deactivated nodes that are deactivated while the inference operation IF is performed. For example, the deactivated nodes may represent nodes that have never been accessed or in which data was never routed while the inference operation IF is performed.

For example, the activation area information AA corresponding to the first inference result value IFRV1 may include an activation level of the plurality of node groups NG1, NG2, and NG3. For example, the activation level of the plurality of node groups NG1, NG2, and NG3 may be calculated by dividing the number of activated nodes by the total number of nodes and converting the value to a percentile. For example, since the first, second, and fourth nodes ND1_A, ND2_A, and ND4_A are activated in the first node group NG1, the activation level of the first node group NG1 may be calculated as ¾*100%=75%. For example, since there are no activated nodes in the second node group NG2, the activation level of the first node group NG2 may be calculated as 0%. For example, since the third node ND3_A is activated in the third node group NG3, the activation level of the first node group NG3 may be calculated as ¼*100%=25%.

For example, the activation area information AA corresponding to the first inference result value IFRV1 may further include information indicating activated nodes. For example, the information indicating activated nodes may include addresses or locations of the activated nodes. For example, the activation area information AA may indicate which of the nodes were activated and in which of node group they are present.

FIG. 5 is a diagram for describing a call count and inference operation in a method of operating an artificial neural network model according to an example embodiment.

Referring to FIG. 5, a process in which an inference operation is performed and activation area information AA and call count CNT are recorded is illustrated, and a process in which operations S300, S400, and S500 in FIG. 1 being repeatedly performed is illustrated.

For example, execution of the artificial neural network model may begin, and the first inference result value IFRV1 may be calculated by the first inference operation IF1 on the first input value. For example, the activation area information AA corresponding to the first inference result value IFRV1 may include the activation level of the first to fifth node groups NG1, . . . , NG5. For example, the call count CNT of the first inference result value IFRV1 may be recorded as ‘l’. For example, after the first inference operation IF1, the second inference operation IF2 may be performed. For example, the second inference result value IFRV2 may be calculated by performing the second inference operation IF2 on the second input value. For example, the activation area information AA corresponding to the second inference result value IFRV2 may be different from the activation area information AA corresponding to the first inference result value IFRV1. For example, the call count CNT of the second inference result value IFRV2 may be recorded as ‘1’.

For example, after the second inference operation IF2, the third inference operation IF3 may be performed. For example, the first inference result value IFRV1 may be calculated by performing the third inference operation IF3 on the third input value. For example, the same inference result value may be calculated for different input values (e.g., the first inference result value IFRV1 for the first and third input values). For example, the activation area information AA may be determined by the inference result value regardless of the temporal sequence of the inference operation. For example, the activation area information AA recorded by the first inference operation IF1 and recorded by the third inference operation IF3 may be the same. For example, the call count CNT of the first inference result value IFRV1 may be recorded as ‘2’.

In some example embodiments, a total of 10000 inference operations may be performed. For example, the call count CNT of the first inference result value IFRV1 may be 4000, the call count CNT of the second inference result value IFRV2 may be 300, the call count CNT of the third inference result value IFRV3 may be 2000, the call count CNT of the fourth inference result value IFRV4 may be 1000, and the call count CNT of the fifth inference result value IFRV5 may be 2700. In this case, since the inference result value having the largest call count CNT is the first inference result value IFRV1, the first operation and the second operation may be performed based on the activation area information AA corresponding to the first inference result value IFRV1. In other example embodiments, the total number of times the inference operation is performed may be variously determined.

FIG. 6 is a flowchart illustrating a first operation in a method of operating an artificial neural network model according to an example embodiment.

Referring to FIG. 6, operations S611 and S612 may be an example of performing the first operation of operation S600 in FIG. 1.

The method of FIG. 6 includes selecting a first reference inference result value from among a plurality of inference result values (operation S611). For example, the first reference inference result value may represent the inference result value having the largest call count among the plurality of inference result values (i.e., a high activation level). For example, the first operation and the second operation may be performed based on activation area information corresponding to the first reference inference result value.

The method of FIG. 6 includes reallocating a plurality of node groups to a plurality of first and second hardware accelerators using a second corresponding manner different from a first corresponding manner (operation S612). For example, a node group having a high activation level may be preferentially reallocated to the plurality of second hardware accelerators that have a faster operating speed than that of the plurality of first hardware accelerators, and accordingly, the execution time of artificial neural network model may be shortened and the power consumption of devices that perform inference operations may be increased. For example, if there are a total of B (B is a positive integer) second hardware accelerators, a total of B node groups having a high activation level may be preferentially allocated to the total of B second hardware accelerators.

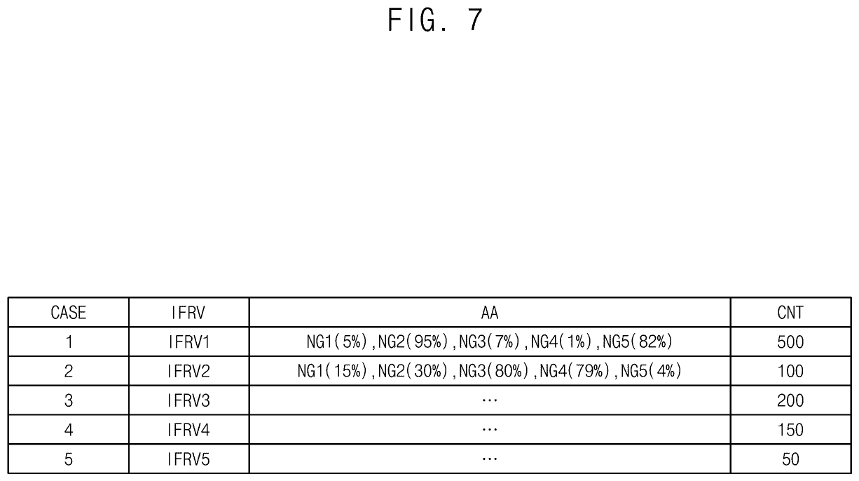

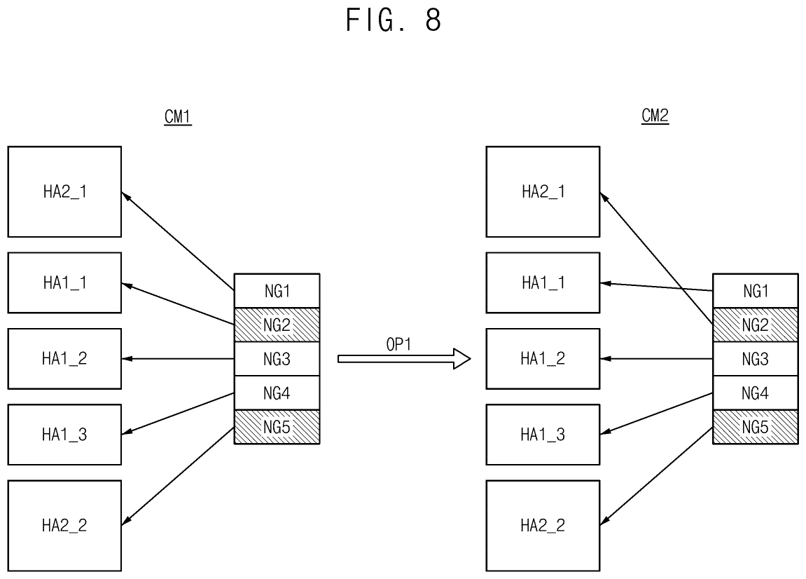

FIGS. 7 and 8 are diagrams for describing a first operation in a method of operating an artificial neural network model according to an example embodiment.

Referring to FIG. 7, selecting a first reference inference result value among a plurality of inference result values (operation S611 in FIG. 6) is illustrated. For example, a total of 1000 inference operations were performed. For example, the call count CNT of the first inference result value IFRV1 is 500, the call count CNT of the second inference result value IFRV2 is 100, the call count CNT of the third inference result value IFRV3 is 200, the call count CNT of the fourth inference result value IFRV4 is 150, and the call count CNT of the fifth inference result value IFRV5 is 50.

For example, since the call count CNT of the first inference result value IFRV1 is the largest, the first inference result value IFRV1 may be selected as the first reference inference result value. Therefore, as will be described with reference to FIG. 8, the first operation may be performed based on the activation area information AA corresponding to the first inference result value IFRV1.

Referring to FIG. 8, a first operation OP1 and operation S612 in FIG. 6 are illustrated. The first operation may be an operation that reallocates a plurality of node groups NG1, NG2, NG3, NG4, and NG5 to a plurality of first hardware accelerators HA1_1, HA1_2, and HA1_3 and a plurality of second hardware accelerators HA2_1 and HA2_2 using a second corresponding manner CM2. In an embodiment, the second corresponding manner CM2 is different from the first corresponding manner CM1.

For example, the first corresponding manner CM1 may represent a manner in which a plurality of node groups NG1, NG2, NG3, NG4, and NG5 were allocated to the plurality of first hardware accelerators HA1_1, HA1_2, and HA1_3 and the plurality of second hardware accelerators HA2_1 and HA2_2 before the artificial neural network model is executed. For example, as described above in FIG. 7, after a total of 1000 inference operations have been performed, the first operation OP1 may be performed.

For example, the second corresponding manner CM2 may represent a manner in which the plurality of node groups NG1, NG2, NG3, NG4, and NG5 are allocated to the plurality of first hardware accelerators HA1_1, HA1_2, and HA1_3 and the plurality of second hardware accelerators HA2_1 and HA2_2 after an inference operation is performed several times. For example, FIGS. 7 and 8 may show a case where there are two second hardware accelerators HA2_1 and HA2_2. In this case, the second node group NG2 (about 95%) and the fifth node group NG5 (about 82%) having a high activation level among the plurality of node groups NG1, NG2, NG3, NG4, and NG5 are preferentially allocated to the plurality of second hardware accelerators HA2_1 and HA2_2.

For example, the second node group NG2 and the fifth node group NG5 may be preferentially reallocated to the plurality of second hardware accelerators HA2_1 and HA2_2 that have a faster operating speed than that of the plurality of first hardware accelerators HA1_1, HA1_2, and HA1_3, and accordingly, the execution time of artificial neural network model may be shortened and the power consumption of devices that perform inference operations may be increased.

FIG. 9 is a flowchart illustrating a second operation in a method of operating an artificial neural network model according to an example embodiment.

Referring to FIG. 9, operations S621 and S622 are an example of performing the second operation of operation S600 in FIG. 1. Operation S621 may be substantially the same as operation S611 in FIG. 6. Hereinafter, descriptions repeated with those of FIGS. 6 and 7 will be omitted.

The method of FIG. 9 includes resetting a plurality of node groups by dividing the artificial neural network model using a second grouping manner different from the first grouping manner (operation S622). For example, by resetting a plurality of node groups such that the number of nodes included in the node groups allocated to the plurality of second hardware accelerators is reduced, memory space and computation limitations may be overcome without a significant difference in the execution time of the artificial neural network model before and after the reset. For example, the activation level of the B (B is a positive integer) node groups may be increased by including deactivated nodes of the B node groups allocated to the plurality of second hardware accelerators in adjacent node groups. In this case, a total number of nodes included in each of the B node groups may decrease and the activation level of each of the B node groups may increase. For example, the activation level of a first node group may be increased by moving a deactivated node of the first node group to a second node group.

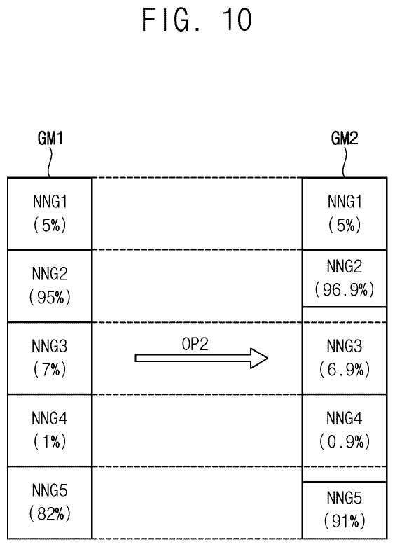

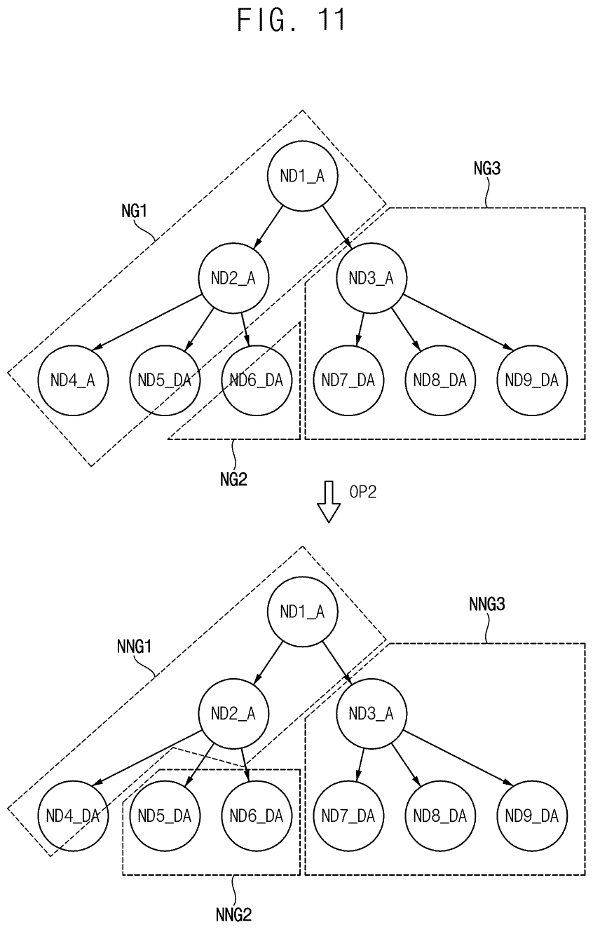

FIGS. 10 and 11 are diagrams for describing a second operation in a method of operating an artificial neural network model according to an example embodiment.

Referring to FIG. 10, a second operation OP2 and operation S622 in FIG. 9 are illustrated. The second operation may be an operation that resets a plurality of node groups NG1, NG2, NG3, NG4, and NG5 using a second grouping manner GM2 different from the first grouping manner GM1.

Hereinafter, it will be assumed that the artificial neural network model includes a total of 500 nodes, and the artificial neural network model is divided so that a plurality of node groups NG1, NG2, NG3, NG4, and NG5 each include 100 nodes. For example, addresses and locations of activated and deactivated nodes included in the plurality of node groups NG1, NG2, NG3, NG4, and NG5 may be included in activation area information AA associated with a first inference result value IFRV1.

For example, a plurality of node groups may be reset so that the number of deactivated nodes included in the second and fifth node groups NG2 and NG5 having a high activation level is reduced. For example, the deactivated nodes included in the second and fifth node groups NG2 and NG5 may be included in adjacent node groups NG3 and NG4. For example, one or more deactivated nodes in NG2 could be moved to NG3 and one or more deactivated nodes in NG5 could be moved to NG4.

For example, the second node group NG2 may include 95 activated nodes and 5 deactivated nodes. For example, 2 of the 5 deactivated nodes of the second node group NG2 may be included in the third node group NG3. In this case, a new second node group NNG2 may include 95 activated nodes and 3 deactivated nodes, and a new third node group NNG3 may include 7 activated nodes and 95 deactivated nodes. Accordingly, the activation level of the new second node group NNG2 may be about 95/98=96.9%, and the activation level of the new third node group NNG3 may be about 7/102=6.9%.

For example, the fifth node group NG5 may include 82 activated nodes and 18 deactivated nodes. For example, 10 of the 18 deactivated nodes of the fifth node group NG5 may be included in the fourth node group NG4. In this case, a new fifth node group NNG5 may include 82 activated nodes and 8 deactivated nodes, and a new fourth node group NNG4 may include 1 activated node and 110 deactivated nodes. Accordingly, the activation level of the new fifth node group NNG5 may be about 82/90=91%, and the activation level of the new fourth node group NNG4 may be about 1/110=0.9%.

As described above with reference to FIG. 10, when only the number of deactivated nodes included in the second and fifth node groups NG2 and NG5 is reduced, the activation level of the second and fifth node groups NG2 and NG5 may actually increase. Accordingly, memory space and computation limitations may be overcome without a significant difference in the execution time of the artificial neural network model before and after the second operation OP2.

Referring to FIG. 11, an example of the second operation OP2 is shown. For example, before the second operation OP2 is performed, the first node group NG1 may be set to include first, second, fourth, and fifth nodes ND1_A, ND2_A, ND4_A, and ND5_DA. For example, the second node group NG2 may be set to include the sixth node ND6_DA. For example, the third node group NG3 may be set to include the third, seventh, eighth, and ninth nodes ND3_A, ND7_DA, ND8_DA, and ND9_DA.

For example, the first node group NG1 may include a total of 4 nodes. For example, the activation level of the first node group NG1 may be 75%, the activation level of the second node group NG2 may 0%, and the activation level of the third node group NG3 may be 25%.

For example, the second operation OP2 may be performed to reduce the number of deactivated nodes included in the first node group NG1. For example, the fifth node ND5_DA included in the first node group NG1 may be included in the second node group NG2. In this case, a new first node group NNG1 may include a total of two nodes. For example, the activation level of the new first node group NNG1 may be 100%, which may be greater than the activation level of the first node group NG1.

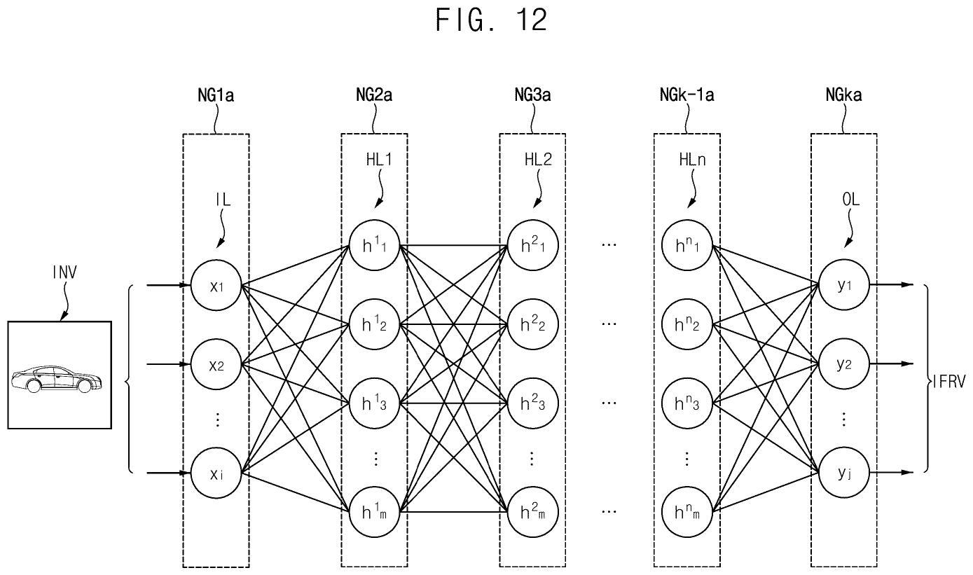

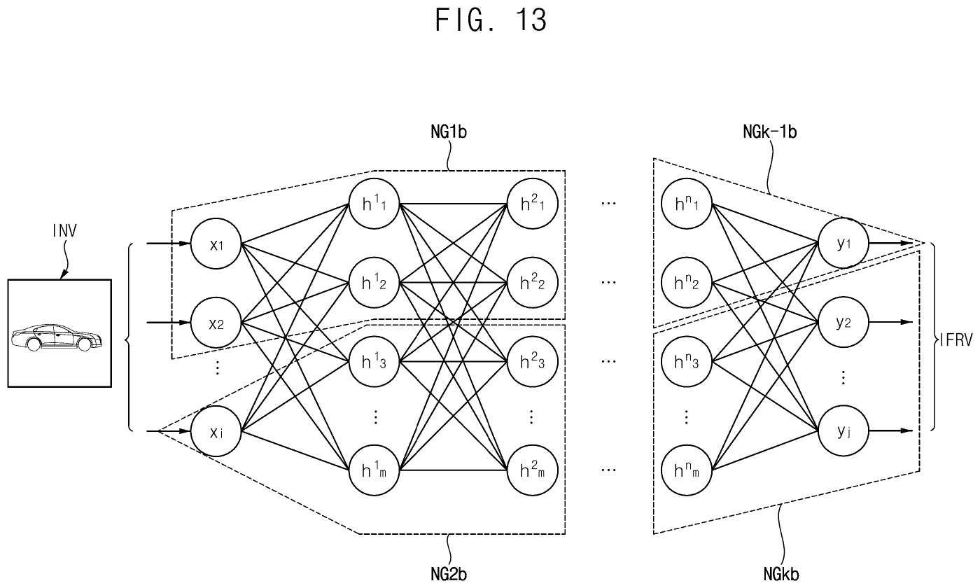

FIGS. 12 and 13 are diagrams illustrating examples of a node grouping manner in a method of operating an artificial neural network model according to example embodiments.

Referring to FIG. 12, a case where nodes included in one of a plurality of layers (e.g., IL, HL1, HL2, . . . , HLn, 0L) is set to one of a plurality of node groups (e.g., NG1a, NG2a, NG3a, . . . , NGk−1a, NGka) is illustrated. A general neural network (or artificial neural network) may include an input layer IL, a plurality of hidden layers HL1, HL2, . . . , HLn and an output layer OL. The input layer IL may include i input nodes x1, x2, . . . , xi, where i is a natural number. An input value INV whose length is i may be input to the input nodes x1 to xi such that each element of the input value INV is input to a respective one of the input nodes x1 to xi. The input value INV may include information associated with the various features of the different classes to be categorized. For example, the input value INV may be array of features, where each feature is output to a corresponding one of the input nodes.

The plurality of hidden layers HL1, HL2, . . . , HLn may include n hidden layers, where n is a natural number, and may include a plurality of hidden nodes h11, h12, h13, . . . , hlm, h21, h22, h23, . . . , h2m, hn1, hn2, hn3, . . . , hnm. For example, the hidden layer HL1 may include m hidden nodes h11 to hlm, the hidden layer HL2 may include m hidden nodes h21 to h2m, and the hidden layer HLn may include m hidden nodes hn1 to hnm, where m is a natural number.

The output layer OL may include j output nodes y1, y2, . . . , yj, where j is a natural number. Each of the output nodes y1 to yj may correspond to a respective one of a plurality of classes to be categorized. The output layer OL may generate output values (e.g., class scores or numerical output such as a regression variable) and/or output data associated with the input value INV for each of the classes. In some example embodiments, the output layer OL may be a fully-connected layer and may generate an inference result value IFRV corresponding to the input value INV.

A structure of the neural network illustrated in FIG. 12 may be represented by information on branches (or connections) between nodes illustrated as lines, and a weighted value assigned to each branch. In some neural network models, nodes within one layer may not be connected to one another, but nodes of different layers may be fully or partially connected to one another. In some other neural network models, such as unrestricted Boltzmann machines, at least some nodes within one layer may also be connected to other nodes within one layer in addition to (or alternatively with) one or more nodes of other layers.

Each node (e.g., the node h11) may receive an output of a previous node (e.g., the node x1), may perform a computing operation, computation or calculation on the received output, and may output a result of the computing operation, computation or calculation as an output to a next node (e.g., the node h21). Each node may calculate a value to be output by applying the input to a specific function (e.g., a nonlinear function). This function may be referred to as the activation function for the node.

In an example embodiment, the structure of the neural network is set in advance, and the weighted values for the connections between the nodes are set appropriately by using sample data having a sample answer (also referred to as a “label”), which indicates a class the data corresponding to a sample input value. The data with the sample answer may be referred to as “training data”, and a process of determining the weighted values may be referred to as “training”. The neural network “learns” to associate the data with corresponding labels during the training process. A group of an independently trainable neural network structure and the weighted values that have been trained using an algorithm may be referred to as a “model”, and a process of predicting, by the model with the determined weighted values, which class new input data belongs to, and then outputting the predicted value, may be referred to as a “testing” process or operating the neural network in an inference mode. Additionally, the process of generating results for new input data based on the patterns trained by the model is referred to as an ‘inference’. In other words, inference refers to an operation of predicting results for unknown data after the model completes training.

In some example embodiments, the neural network may be set so that first to kth (k is a positive integer) node groups NG1a, NG2a, NG3a, . . . , NGk−1a, and NGka correspond to the input layer IL, the plurality of hidden layers HL1, HL2, . . . , and HLn, and the output layer OL, respectively.

For example, the first node group NG1a may include input nodes x1, x2, . . . , and xi. For example, the second to k−1th node groups NG2a, NG3a, . . . , and NGk−1a may include hidden nodes h11, h12, h13, . . . , hlm, h21, h22, h23, . . . , h2m, hn1, hn2, hn3, . . . , and hnm. For example, the kth node group NGka may include output nodes y1, y2, . . . , and yj.

Referring to FIG. 13, at least some of the nodes included in two or more layers among the plurality of layers (e.g., IL, HL1, HL2, . . . , HLn, and OL) are set to one of a plurality of node groups (e.g., NG1b, NG2b, . . . , NGk−1b, and NGkb). For example, in FIG. 13, a grouping manner different from that in FIG. 12 is illustrated. Hereinafter, descriptions repeated with those of FIG. 12 will be omitted.

In some example embodiments, the first to kth node groups NG1b, NG2b, . . . , NGk−1b, and NGkb of the neural network may be set regardless of the input layer IL, the plurality of hidden layers HL1, HL2, . . . , and HLn, and output layer OL.

For example, the first node group NG1b may include some of the input nodes x1 and x2, some of the hidden nodes h11, h12, h21 and h22. For example, the second node group NG2b may include some of the input nodes xi, some of the hidden nodes h13, . . . , hlm, h23, . . . , and h2m.

In other example embodiments, the neural network may be set so that the first to kth node groups NG1b, NG2b, . . . , NGk−1b, and NGkb include the same number of nodes, but the grouping manner used for dividing the neural network is not limited to the above description.

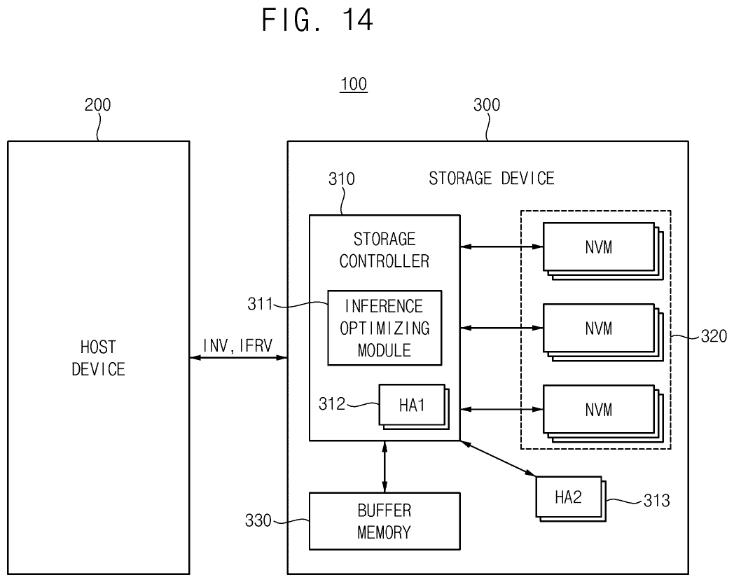

FIG. 14 is a block diagram illustrating a storage device and a storage system including the storage device according to an example embodiment.

Referring to FIG. 14, a storage system 100 includes a host device 200 and a storage device 300.

The host device 200 may control overall operation of the storage system 100. For example, the host device 200 may include a host processor and a host memory. For example, the host processor may control operation of the host device 200 and may run an operating system (OS). For example, the host memory may store instructions and data that are executed and processed by the host processor. For example, the OS executed by the host processor may include a file system for file management and a device driver for controlling peripheral devices including the storage device 300 at OS level.

The storage device 300 may be accessed by the host device 200. The storage device 300 may include a storage controller 310 (e.g., a control circuit), a plurality of non-volatile memories (NVMs) 320, a buffer memory 330, a plurality of first hardware accelerators 312, and a plurality of second hardware accelerators 313. The storage controller 310 may include an inference optimizing module 311. The storage device 300 may store program codes for executing an artificial neural network model.

The storage controller 310 may control an operation of the storage device 300. For example, the storage controller 310 may control operation of the plurality of non-volatile memories 320, the plurality of first hardware accelerators 312, and the plurality of second hardware accelerators 313 based on commands and data received from the host device 200. For example, the storage controller 310 may receive an input value INV from the host device 200 and transmit an inference result value IFRV corresponding to the input value (INV) to the host device 200.

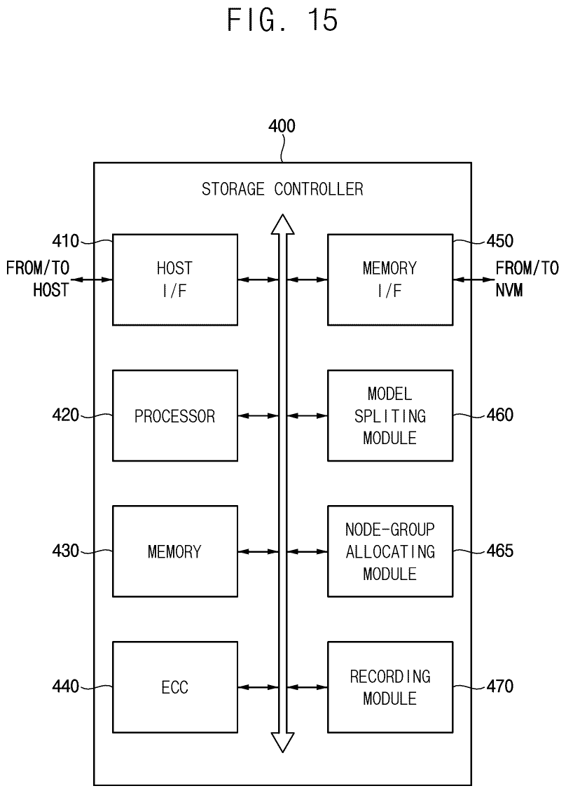

The storage controller 310 may include an inference optimizing module 311 for performing a method of operating an artificial neural network model according to an example embodiment. For example, as will be described with reference to FIG. 15, the inference optimizing module 311 may be implemented including a model splitting module, a node group allocating module, and a recording module. The model splitting module sets a plurality of node groups by dividing the artificial neural network model, and each of the plurality of node groups including at least one of the plurality of nodes. The node group allocating module allocates the plurality of node groups to the plurality of hardware accelerators. The recording module records for each of the plurality of inference result values, activation area information of the plurality of node groups and a call count.

For example, the model splitting module may perform the second operation (e.g., OP2 in FIG. 10), and the node group allocating module may perform the first operation (e.g., OP1 in FIG. 8). The plurality of non-volatile memories 320 may store data. For example, the data may include an artificial neural network model including a plurality of nodes.

In some example embodiments, each of the plurality of nonvolatile memories 320 may include a NAND flash memory. In other example embodiments, each of the plurality of nonvolatile memories 320 may include one of an electrically erasable programmable read only memory (EEPROM), a phase change random access memory (PRAM), a resistive random access memory (RRAM), a nano floating gate memory (NFGM), a polymer random access memory (PoRAM), a magnetic random access memory (MRAM), a ferroelectric random access memory (FRAM), or the like.

The buffer memory 330 may store instructions and/or data that are executed and/or processed by the storage controller 310, and may temporarily store data stored in or to be stored into the plurality of nonvolatile memories 320. For example, the artificial neural network model may be stored in the buffer memory 330. For example, the buffer memory 330 may include at least one of various volatile memories, e.g., a dynamic random access memory (DRAM) or a static random access memory (SRAM).

The plurality of first and second hardware accelerators 312 and 313 may be included in the storage device 300. For example, the plurality of first and second hardware accelerators 312 and 313 may represent devices that perform some functions in computing faster than a central processing unit. For example, the plurality of first and second hardware accelerators 312 and 313 may represent devices that perform inference operations faster than a central processing unit included in the storage device 300.

For example, the plurality of first and second hardware accelerators 312 and 313 may be implemented with a graphic processing unit (GPU), field programmable gate array (FPGA), application specific integrated circuits (ASIC) or application specific standard part (ASSP). For example, the first and second hardware accelerators 312 and 313 may have a computing device and a memory space that are separate from the storage device 300.

For example, the plurality of second hardware accelerators 313 may have faster operating speed than that of the plurality of first hardware accelerators 312. In some example embodiments, a plurality of first hardware accelerators 312 may be included in the storage controller 310, and a plurality of second hardware accelerators 313 may be disposed outside the storage controller 310. For example, the plurality of first hardware accelerators 312 may be an embedded field-programmable gate array (eFPGA), and the plurality of second hardware accelerators 313 may be a field-programmable gate array (FPGA).

For example, a single node group among the plurality of node groups may be assigned a single hardware accelerator among the first and second hardware accelerators 312 and 313. For example, each of the first and second hardware accelerators 312 and 313 may perform a sub-inference operation on a single allocated node group to generate plurality of sub-inference result values, and the plurality of sub-inference result values may be transmitted to the storage controller 311. For example, the storage controller 311 may calculate an inference result value IFRV from the plurality of sub-inference result values.

In some example embodiments, the storage device 300 may be a solid state drive (SSD). In other example embodiments, the storage device 300 may be one of a universal flash storage (UFS), a multi media card (MMC), an embedded multi media card (eMMC), a secure digital (SD) card, a micro SD card, a memory stick, a chip card, a universal serial bus (USB) card, a smart card, a compact flash (CF) card, or the like.

In some example embodiments, the storage device 300 may be connected to the host device 200 through a block accessible interface which may include, for example, a UFS, an eMMC, a serial advanced technology attachment (SATA) bus, a nonvolatile memory express (NVMe) bus, a serial attached SCSI (SAS) bus, or the like. The storage device 300 may use a block accessible address space corresponding to an access size of the plurality of nonvolatile memories 320 to provide the block accessible interface to the host device 200, for allowing access by units of a memory block with respect to data stored in the plurality of nonvolatile memories 320.

In some example embodiments, the storage system 100 may be any mobile system, such as a mobile phone, a smart phone, a tablet computer, a laptop computer, a personal digital assistant (PDA), a portable multimedia player (PMP), a digital camera, a portable game console, a music player, a camcorder, a video player, a navigation device, a wearable device, an internet of things (IoT) device, an internet of everything (IoE) device, an e-book reader, a virtual reality (VR) device, an augmented reality (AR) device, a robotic device, etc. In other example embodiments, the storage system 100 may be any computing system, such as a personal computer (PC), a server computer, a workstation, a digital television, a set-top box or a navigation system.

FIG. 15 is a block diagram illustrating a storage controller included in a storage device according to example embodiments.

Referring to FIG. 15, a storage controller 400 includes a host interface 410, a processor 420, a memory 430, an Error Correction Code (ECC) module 440, a memory interface 450, a model splitting module 460, a node-group allocating module 465, and a recording module 470.

The processor 420 may control an operation of the storage controller 400 in response to a command received via the host interface 410 from a host (e.g., the host device 200 in FIG. 14). In some example embodiments, the processor 420 may control respective components by employing firmware for operating a storage device (e.g., the storage device 300 in FIG. 14).

The memory 430 may store instructions and data executed and processed by the processor 420. For example, the memory 430 may be implemented with a volatile memory device with relatively small capacity and high speed, such as a static random access memory (SRAM) or a cache memory.

The ECC block 440 for error correction may perform coded modulation using a Bose-Chaudhuri-Hocquenghem (BCH) code, a low density parity check (LDPC) code, a turbo code, a Reed-Solomon code, a convolution code, a recursive systematic code (RSC), a trellis-coded modulation (TCM), a block coded modulation (BCM), etc., or may perform ECC encoding and ECC decoding using above-described codes or other error correction codes.

The host interface 410 may provide physical connections between the host device 200 and the storage device 300. The host interface 410 may provide an interface corresponding to a bus format of the host for communication between the host device 200 and the storage device 300. In some example embodiments, the bus format of the host device 200 may be a small computer system interface (SCSI) or a serial attached SCSI (SAS) interface. In other example embodiments, the bus format of the host device 200 may be a USB, a peripheral component interconnect (PCI) express (PCIe), an advanced technology attachment (ATA), a parallel ATA (PATA), a serial ATA (SATA), a nonvolatile memory (NVM) express (NVMe), etc., format.

The memory interface 450 may exchange data with nonvolatile memories (e.g., the nonvolatile memories 320 in FIG. 2). The memory interface 450 may transfer data to the nonvolatile memories 320, or may receive data read from the nonvolatile memories 320. In some example embodiments, the memory interface 450 may be connected to the nonvolatile memories 320 via one channel. In other example embodiments, the memory interface 450 may be connected to the nonvolatile memories 320 via two or more channels.

The model splitting module 460 may perform operation S100 in FIG. 1. For example, the model splitting module 460 may set a plurality of node groups by dividing the artificial neural network model, where each of the plurality of node groups includes at least one of the plurality of nodes. The model splitting module 460 may perform a portion of operation S600 in FIG. 1. For example, the model splitting module 460 may perform a second operation (e.g., OP2 in FIG. 10) to change a division of the artificial neural network model.

The node-group allocating module 465 may perform operation S200 in FIG. 1. For example, the node-group allocating module 465 may allocate the plurality of node groups to a plurality of first and second hardware accelerators (e.g., 312 and 313 in FIG. 14). The node-group allocating module 465 may perform a portion of operation S600 in FIG. 1. For example, the node-group allocating module 465 may perform a first operation (e.g., OP1 in FIG. 8) to change allocation of the plurality of node groups to a plurality of first and second hardware accelerators (e.g., 312 and 313 in FIG. 14)

The recording module 470 may perform operation S500 in FIG. 1. For example, for each inference result value, the recording module 470 may record activation area information of the plurality of node groups and call count. In some example embodiments, a portion or all of the model splitting module 460, the node-group allocating module 465, and the recording module 470 may be implemented in the form of hardware. For example, a portion or all of the model splitting module 460, the node-group allocating module 465, and the recording module 470 may be included in the processor 420 or may be included in a computer-based electronic circuit or logic.

In some example embodiments, a portion or all of the model splitting module 460, the node-group allocating module 465, and the recording module 470 may be implemented in the form of software. For example, the model splitting module 460, the node-group allocating module 465, and the recording module 470 may be implemented in the form of instructions or program codes executed by the processor 420. For example, the model splitting module 460, the node-group allocating module 465, and the recording module 470 may be stored in a computer-readable recording medium. For example, the processor 420 may load instructions of the model splitting module 460, the node-group allocating module 465, and the recording module 470 to the memory 430.

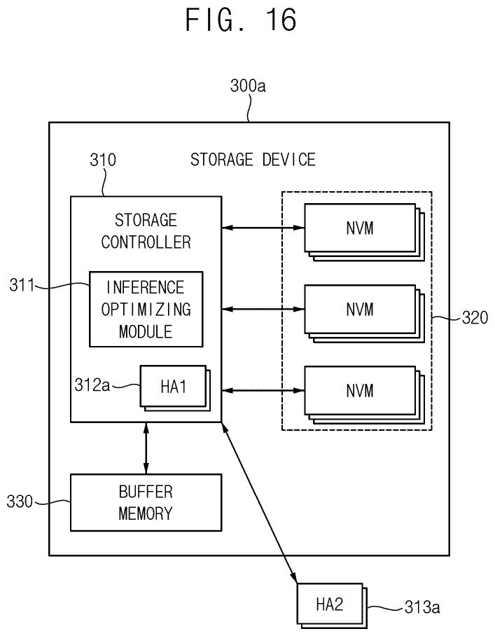

FIG. 16 is a diagram illustrating an example of a storage device according to an example embodiment.

Referring to FIG. 16, an example in which a plurality of second hardware accelerators 313a are disposed outside the storage device 300a is illustrated. Hereinafter, descriptions repeated with those of FIG. 14 will be omitted.

For example, a plurality of first hardware accelerators 312a may be included in the storage device 300a, and the plurality of second hardware accelerators 313a may be disposed outside the storage device 300a. For example, the storage device 300a may use a plurality of second hardware accelerators 313a that are not included in the storage device 300a to execute an artificial neural network model. Additionally, the plurality of second hardware accelerators 313a may have operating speed faster than that of the plurality of first hardware accelerators 312a. For example, the execution time of the artificial neural network model may be shorter in the second plurality of hardware accelerators 313a than in the first plurality of hardware accelerators 312a.

The inventive concept may be applied to various electronic devices and systems that include a storage device. For example, the inventive concept may be applied to systems such as a personal computer (PC), a server computer, a data center, a workstation, a mobile phone, a smart phone, a tablet computer, a laptop computer, a personal digital assistant (PDA), a portable multimedia player (PMP), a digital camera, a portable game console, a music player, a camcorder, a video player, a navigation device, a wearable device, an internet of things (IoT) device, an internet of everything (IoE) device, an e-book reader, a virtual reality (VR) device, an augmented reality (AR) device, a robotic device, a drone, etc.

The foregoing is illustrative of example embodiments and is not to be construed as limiting thereof. Although some example embodiments have been described, those skilled in the art will readily appreciate that many modifications are possible in the example embodiments without materially departing from the teachings of the example embodiments. Accordingly, all such modifications are intended to be included within the scope of the example embodiments.

What is claimed is:

1. A method of operating an artificial neural network model including a plurality of nodes, the method comprising:
dividing the artificial neural network model into a divided artificial neural network including a plurality of node groups using a first grouping manner, each of the plurality of node groups including at least one of the plurality of nodes;
allocating a first subset of the plurality of node groups to a plurality of first hardware accelerators and a second other subset of the plurality of node groups to a plurality of second hardware accelerators using a first corresponding manner to generate an allocation, where operating speeds of the plurality of second hardware accelerators are faster than operating speeds of the plurality of first hardware accelerators;
executing the divided artificial neural network model on a plurality of input values using the plurality of first and second hardware accelerators to generate a plurality of inference result values;
for each of the plurality of inference result values, recording activation area information of the plurality of node groups and a call count; and
performing at least one of a first operation to change the allocation and a second operation to change the divided artificial neural network model, based on the activation area information and the call count.

2. The method of claim 1, wherein the activation area information of the plurality of node groups includes information indicating which of the plurality of nodes is activated when the artificial neural network model is executed.

3. The method of claim 1, wherein the call count indicates a number of times each of the plurality of inference result values is calculated.

4. The method of claim 1, wherein performing at least one of the first operation and the second operation comprises:
performing the first operation based on a first reference inference result value which has a largest call count among the plurality of inference result values.

5. The method of claim 4, wherein performing the first operation comprises:
selecting the first reference inference result value among the plurality of inference result values; and
reallocating the plurality of node groups to the plurality of first and second hardware accelerators using a second corresponding manner different from the first corresponding manner, based on the activation area information of the plurality of node groups for the first reference inference result value.

6. The method of claim 5, wherein, when the plurality of node groups are reallocated to the plurality of first and second hardware accelerators in the second corresponding manner, N of the node groups in order of high activation level among the plurality of node groups are allocated to N of the second hardware accelerators, where N is a positive integer.

7. The method of claim 1, wherein performing at least one of the first operation and the second operation comprises:
performing the second operation based on a first reference inference result value which has a largest call count among the plurality of inference result values.

8. The method of claim 7, wherein performing the second operation comprises:
selecting the first reference inference result value among the plurality of inference result values; and
dividing the artificial neural network model into a new divided artificial neural network using a second grouping manner different from the first grouping manner, based on the activation area information of the plurality of node groups for the first reference inference result value.

9. The method of claim 8, wherein dividing the artificial neural network model into the new divided artificial neural network decreases a number of deactivated nodes included in one of the node groups that has an activation level greater than a certain threshold.

10. The method of claim 1,
wherein program codes for executing the artificial neural network model are stored in a storage device including a storage controller and a plurality of non-volatile memories controlled by the storage controller,
wherein the plurality of first and second hardware accelerators are included in the storage device, and
wherein the artificial neural network model is executed by the storage device.

11. The method of claim 10, wherein the plurality of first hardware accelerators are included in the storage controller, and the plurality of second hardware accelerators are disposed outside the storage controller.

12. The method of claim 11, wherein the plurality of first hardware accelerators are embedded field-programmable gate arrays (eFPGAs), and the plurality of second hardware accelerators are field-programmable gate arrays (FPGAs).

13. The method of claim 11, wherein the plurality of first and second hardware accelerators are graphic processing units (GPUs).

14. The method of claim 1,
wherein program codes for executing the artificial neural network model are stored in a storage device,
wherein the plurality of first hardware accelerators are included in the storage device, and the plurality of second hardware accelerators are disposed outside the storage device, and
wherein the artificial neural network model is executed by the storage device.

15. The method of claim 1,
wherein the artificial neural network model includes a plurality of layers, and
wherein nodes included in a layer among the plurality of layers are assigned to one of the plurality of node groups.

16. The method of claim 1, wherein
wherein the artificial neural network model includes a plurality of layers, and
wherein at least some of nodes included in two or more layers among the plurality of layers are assigned to one of the plurality of node groups.

17. A storage device comprising:
a plurality of non-volatile memories configured to store an artificial neural network model including a plurality of nodes;
a plurality of hardware accelerators configured to calculate a plurality of inference result values based on a plurality of input values and the artificial neural network model; and
a storage controller configured to control the plurality of non-volatile memories and the plurality of hardware accelerators,
wherein the storage controller comprises:
a model splitting module configured to divide the artificial neural network model into a plurality of node groups, each of the plurality of node groups including at least one of the plurality of nodes;
a node group allocating module configured to allocate each of the plurality of node groups to a corresponding one of the plurality of hardware accelerators to generate an allocation; and
a recording module configured to, for each of the plurality of inference result values, record activation area information of the plurality of node groups and a call count,
wherein the node group allocating module is configured to perform a first operation to change the allocation based on the activation area information and the call count, and
wherein the model splitting module is configured to perform a second operation to change the divided artificial neural network based on the activation area information and the call count.

18. The method of claim 17,
wherein the plurality of hardware accelerators comprise a plurality of first hardware accelerators and a plurality of second hardware accelerators having operating speeds faster than those of the plurality of first hardware accelerators,
wherein the plurality of first hardware accelerators are included in the storage controller, and
wherein the plurality of second hardware accelerators are disposed outside the storage controller.

19. The method of claim 17, further comprising:
a buffer memory configured to temporarily store the artificial neural network model, and
wherein the storage controller is configured to control the buffer memory.

20. A method of operating an artificial neural network model including a plurality of nodes, the method comprising:
dividing the artificial neural network model into a divided artificial neural network including a plurality of node groups using a first grouping manner, each of the plurality of node groups including at least one of the plurality of nodes;
allocating a first subset of the plurality of node groups to a plurality of first hardware accelerators and a second other subset of the plurality of node groups to a plurality of second hardware accelerators using a first corresponding manner, where operating speeds of the plurality of second hardware accelerators being faster than operating speeds of the plurality of first hardware accelerators;
executing the divided artificial neural network model on a plurality of input values using the plurality of first and second hardware accelerators to generate a plurality of inference result values;
for each of the plurality of inference result values, recording activation area information of the plurality of node groups and a call count;
selecting a first reference inference result value among the plurality of inference result values;
reallocating the plurality of node groups to the plurality of first and second hardware accelerators using a second corresponding manner different from the first corresponding manner, based on the activation area information of the plurality of node groups for the first reference inference result value; and
dividing the artificial neural network model into a new divided artificial neural network using a second grouping manner different from the first grouping manner, based on the activation area information.
